(19) United States
(12) Patent Application Publication
(10) Pub. No.: US 2026/0221366 A1
(43) Pub. Date: Jul. 30, 2026

(54) INSTANTANEOUS TRIP APPARATUS OF MOLDED CASE CIRCUIT BREAKER

(71) Applicant: LS ELECTRIC CO., LTD., Anyang-si, Gyeonggi-do (KR)

(72) Inventors: Younghwan KIM, Anyang-si, Gyeonggi-do (KR); Jihyoung KIM, Anyang-si, Gyeonggi-do (KR); Hasu KIM, Anyang-si, Gyeonggi-do (KR); Kihwan OH, Anyang-si, Gyeonggi-do (KR)

(21) Appl. No.: 19/144,640

(22) PCT Filed: Jan. 8, 2024
(86) PCT No.: PCT/KR2024/000340

§ 371 Date: Jun. 30, 2025

(30) Foreign Application Priority Data
Jan. 19, 2023 (KR) 10-2023-0007777

(51) Int. Cl. H01H 71/40; H01H 71/02; H01H 71/12; H01H 71/16

(52) U.S. Cl. CPC H01H 71/402; H01H 71/0207; H01H 71/123; H01H 71/164; H01H 2071/124

(57) ABSTRACT

The present disclosure relates to an instantaneous trip apparatus for a molded case circuit breaker and, more specifically, to an instantaneous trip apparatus for a molded case circuit breaker with improved blocking performance due to increased magnetic attraction. According to the instantaneous trip apparatus for a molded case circuit breaker according to one embodiment of the present disclosure, a heater is formed in a solenoid shape to generate a circular current. Accordingly, instantaneous suction force is strengthened by matching the direction of the magnetic field generated in a magnet with the direction in which an armature operates.

### CROSS-REFERENCE TO RELATED APPLICATIONS

This application is the National Stage filing under 35 U.S.C. 371 of International Application No. PCT/KR 2024/000340, filed on Jan. 8, 2024, which claims the benefit of earlier filing date and right of priority to Korean Application No. 10-2023-0007777, filed on Jan. 19, 2023, the contents of which are all hereby incorporated by reference herein in their entirety.

### FIELD

The present disclosure relates to an instantaneous trip apparatus of a molded case circuit breaker, and more particularly, to an instantaneous trip apparatus of a molded case circuit breaker having improved breaking performance by increasing magnetic attraction force.

### BACKGROUND

In general, a molded case circuit breaker (MCCB) is an electrical device that automatically interrupts a circuit in the event of an electrical overload or short circuit to protect the circuit and load. Molded case circuit breakers are commonly used in low voltage systems.

A molded case circuit breaker largely consists of a terminal part that can be connected to a power source side or a load side, a contact part including a stationary contactor and a movable contactor that is in contact with or separated from the stationary contactor to be connected to or separated from a circuit, a switching mechanism that provides power necessary to switch the circuit by moving the movable contactor, a trip part that detects an overcurrent or short-circuit current flowing in the circuit to induce a trip operation of the switching mechanism, and an arc extinguishing part that extinguishes an arc generated when an abnormal current is interrupted.

Fault current may be divided into several types, wherein usually a current exceeding 130% of a rated current is called an overcurrent, and a sudden current exceeding 10 times the rated current is called an instantaneous fault current. In addition, a sudden large current including an instantaneous current is called a short-circuit current.

In an overcurrent range, a method of tripping a circuit breaker usually using a bimetal element is mainly used, and in the case of an instantaneous current of about 10 times the rated current, when a current above a set current flows through a conductor (heater) placed between a magnet and an armature, a method of tripping the circuit breaker by forming a magnetic path and attracting the armature to the magnet is used.

In this way, the molded case circuit breaker includes an overcurrent trip apparatus corresponding to the rated overcurrent and an instantaneous trip apparatus corresponding to the instantaneous current.

FIG. 1 shows a molded case circuit breaker 1 according to the related art, and FIG. 2 shows a trip part (trip apparatus) 10.

The trip part 10 for detecting an abnormal current flowing in a circuit and tripping a switching mechanism is provided inside an enclosure 2. The trip part 10 is usually provided on a load side. The trip part 10 may include a heater 11 connected to a load side terminal part 9, a bimetal (not shown) coupled to the heater 11 to detect heat and bend according to an amount of heat, a magnet 13 and an armature 14 provided around the heater 11, a crossbar 15 provided so as to be rotatable by contact with the bimetal or the armature 14, and a shooter 16 that is restrained or released by the rotation of the crossbar 15 to bind or release a nail 18 of a switching mechanism 20.

Typically, the bimetal is bent by heat generated from the heater 11 to rotate the crossbar 15 so as to operate the switching mechanism during a small current delay interruption, and the armature 14 is attracted by a magnetic force excited by the magnet 13 to rotate the crossbar 15 so as to operate the switching mechanism 20 during a large current instantaneous interruption.

FIGS. 3 and 4 show operation diagrams of an instantaneous trip apparatus. When a large fault current such as a short-circuit current occurs on a circuit where the molded case circuit breaker 1 is installed, an induced current is generated in the magnet 13, and at this time, the armature 14 is attracted by an attraction force of a magnetic field of the magnet 13 to push the crossbar 15 to rotate, and accordingly, the switching mechanism 20 is tripped while rotating the shooter 16.

In the trip part, when a fault current occurs, an attraction force is applied to the magnet 13 due to a magnetic field generated around the heater 11 through which current flows to pull the armature 14.

When a normal current is applied, the attraction force is weaker than a tension of an instantaneous spring 12 of the armature 14 so as not to pull the armature 14, but when an accident current occurs, the attraction force of the magnet 13 becomes stronger than the tension of the instantaneous spring 12 due to an increased strength of the magnetic field so as to attract the armature 14.

That is, when the normal current is applied, the magnetic attraction force of the magnet 13 is smaller than the tension of the instantaneous spring 12, and thus the armature 14 does not operate.

However, when a fault current is applied, the magnetic attraction force of the magnet 13 becomes greater than the tension of the instantaneous spring 12 to move the armature 14, and operate the mechanism so as to perform a trip operation.

However, in the case of a low-rated circuit breaker, a size of the current is small, and thus, when a fault current occurs, the magnetic attraction force of the magnet is not sufficient, and the armature may not operate within an instantaneous reference range.

Therefore, in order to increase an instantaneous attraction force, a size of the magnet must be increased, but due to a spatial constraint, there is a limit to the size of the magnet that can be increased, and thus, there is a limit to the attraction force.

FIG. 5 shows a perspective view of a heater according to the related art. A direction of a current flowing in the heater 11 and a direction of the magnetic field are shown. A magnetic field is formed according to the right-hand screw rule around the current flowing in the heater.

FIG. 6 shows a perspective view of a heater and a magnet according to the related art. A magnetic field formed around the magnet 13 by a current flowing through the heater 11 is shown. The magnet is formed in a shape that surrounds the heater, that is, in a ‘I’ shape. Therefore, a rearward-facing magnetic field is formed on one side surface of the magnet, and a forward-facing magnetic field is formed on the other side surface of the magnet. However, a direction of the magnetic field is offset from a direction of movement of the armature 14, and thus, an effect of increasing the magnetic attraction force is not large.

### SUMMARY

The present disclosure has been made to solve the above-mentioned problems, and an aspect of the present disclosure is to provide an instantaneous trip apparatus of a molded case circuit breaker that increases an instantaneous attraction force so as to allow an armature trip operation to be performed well even at low ratings.

An instantaneous trip apparatus of a molded case circuit breaker according to one embodiment of the present disclosure may include a heater connected to a circuit; a magnet provided adjacent to the heater; and an armature that is rotatably provided to be attracted in a direction of the magnet when the magnet is magnetized, wherein a magnetic groove is disposed in a central portion of the heater, and a protruding part is provided on the magnet so as to be inserted into the magnetic groove to protrude toward the armature.

Here, the heater may include a power source side heater part connected to a power source side, a load side heater part some of which is disposed to overlap the power source side heater part, and an insulating member interposed between the power source side heater part and the load side heater part.

In addition, the power source side heater part may include a power source side connection terminal connected to a power source side, a power source side first vertical plate part that is connected to the power source side connection terminal to extend downward, a power source side middle part extending horizontally from the power source side first vertical plate part, and a power source side coupling part connected to the power source side middle part.

In addition, the load side heater part may include a load side coupling part coupled to the power source side coupling part, a load side first vertical plate part extending upward from the load side coupling part, a load side middle part extending horizontally from the load side first vertical plate part, a load side second vertical plate part extending downward from the load side middle part to be disposed in parallel to the load side first vertical plate part, a load side flat plate part that extends by bending from the load side second vertical plate part, and a load side terminal part connected to the load side flat plate part.

In addition, a width of the power source side first vertical plate part may be disposed to be less than half that of the power source side connection terminal.

In addition, a width of the load side first vertical plate part and the load side second vertical plate part may be disposed to be less than half that of the load side flat plate part.

In addition, the load side second vertical plate part and the power source side first vertical plate part may be disposed to overlap with the insulating member interposed therebetween.

In addition, the magnetic groove may be disposed between the load side first vertical plate part and the load side second vertical plate part.

In addition, the insulating member may include an insulating vertical plate part and an insulating horizontal plate part.

In addition, the magnet may include a fixing plate part fixedly provided in a trip part case, and a protruding part that protrudes in a orthogonal direction from the fixing plate part to be inserted into the magnetic groove.

Furthermore, a fixing groove to be fixedly provided in the trip part case may be disposed on the fixing plate part.

According to an instantaneous trip apparatus of a molded case circuit breaker in accordance with one embodiment of the present disclosure, a heater is disposed in a solenoid shape to generate a circular current. Therefore, a direction of a magnetic field formed in a magnet corresponds to a direction in which an armature moves so as to enhance an instantaneous attraction force.

In addition, a magnetic attraction force is enhanced by a protruding part of the magnet that corresponds to a direction of movement of the amateur.

This allows the armature to operate within an instantaneous reference range even at low rated currents.

The heater consists of double plates of a power source side heater part and a load side heater part connected thereto so as to form a circular current.

An insulating member is interposed between the power source side heater part and the load side heater part to facilitate the flow of current between the double plates.

### BRIEF DESCRIPTION OF THE DRAWINGS

FIG. 1 shows a molded case circuit breaker according to the related art.

FIG. 2 shows a trip part of a molded case circuit breaker according to the related art.

FIGS. 3 and 4 are operation diagrams of an instantaneous trip mechanism in a trip part of a molded case circuit breaker according to the related art, in which FIG. 3 shows an energized state, and FIG. 4 shows a tripped state.

FIG. 5 shows a perspective view of a heater according to the related art.

FIG. 6 shows a perspective view of a heater and a magnet according to the related art.

FIG. 7 is an internal cross-sectional view of a molded case circuit breaker according to one embodiment of the present disclosure.

FIGS. 8 and 9 are perspective views of a trip part applied to a molded case circuit breaker according to one embodiment of the present disclosure, which are viewed from different directions.

FIG. 10 is a perspective view of a heater and a magnet applied to a trip part of a molded case circuit breaker according to one embodiment of the present disclosure.

FIG. 11 is an exploded perspective view of FIG. 10.

FIG. 12 is an exploded perspective view of a heater in FIG. 10.

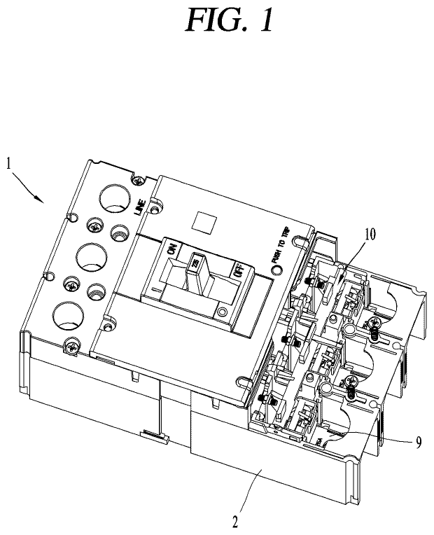

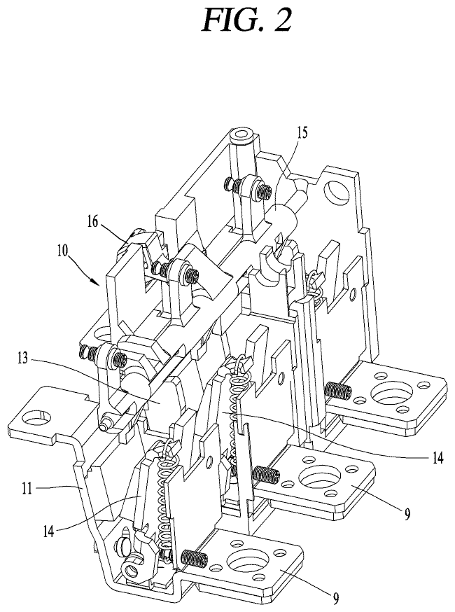

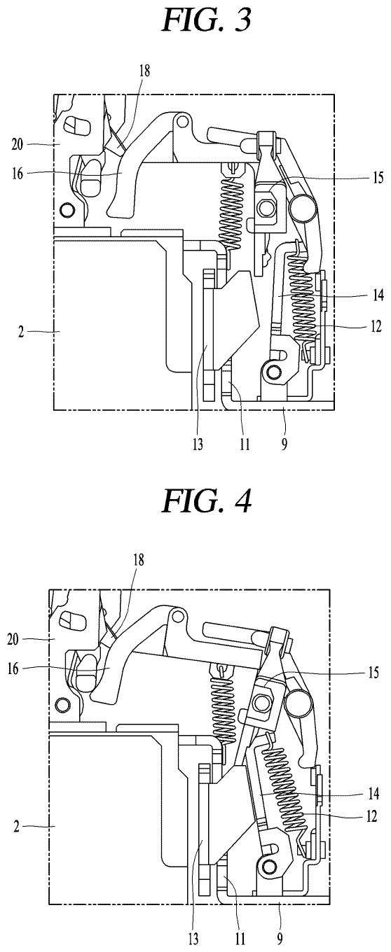

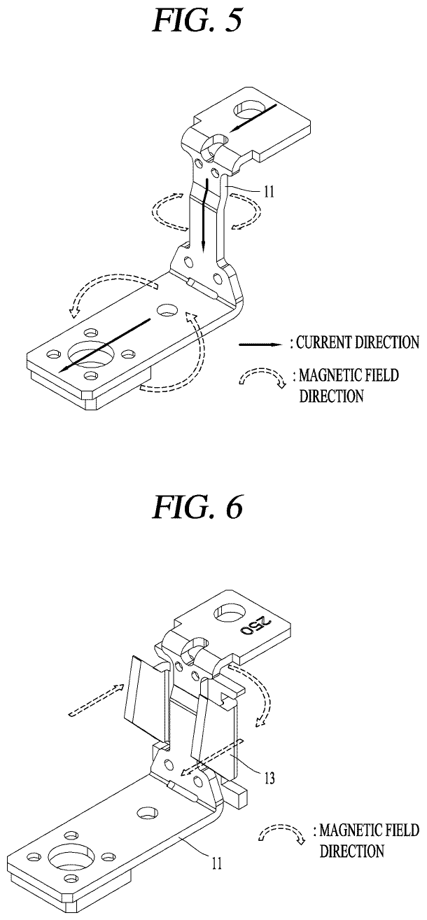

### DETAILED DESCRIPTION

Hereinafter, preferred embodiments of the present disclosure will be described with reference to the accompanying drawings. However, this is intended to describe in detail to an extent that those skilled in the art to which the present disclosure belongs can easily carry out the disclosure, and does not mean that the technical concept and scope of the present disclosure are limited by those drawings.

The term “member” or “part” used to refer to an element in the present disclosure is not used for any purpose of limitation, and may also be omitted.

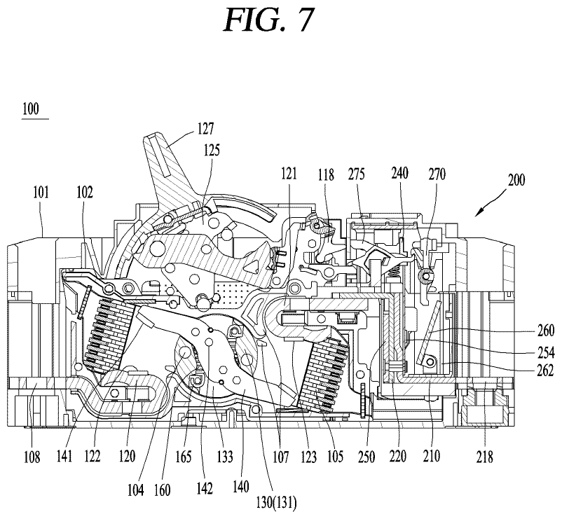

An instantaneous trip apparatus of a molded case circuit breaker according to each embodiment of the present disclosure will be described in detail with reference to the drawings. FIG. 7 shows an internal cross-sectional view of a molded case circuit breaker according to one embodiment of the present disclosure.

An instantaneous trip apparatus of a molded case circuit breaker 100 according to one embodiment of the present disclosure includes a trip part case 280; a heater 210 provided in the trip part case 280 and connected to a circuit; a magnet 250 provided adjacent to the heater 210; an armature 260 that is rotatably provided on the heater 210 to be attracted when the magnet 250 is magnetized; and a crossbar 270 that rotates by an operation of the armature 260 to trip a switching mechanism 125, wherein a magnetic groove 213 is disposed in a central portion of the heater 210, and a protruding part 254 is provided on the magnet 250 so as to be inserted into the magnetic groove to protrude toward the armature 260.

First, a molded case circuit breaker 100 according to one embodiment of the present disclosure will be examined.

An enclosure 101 receives and supports elements of the molded case circuit breaker. The enclosure 101 is roughly disposed into a box shape. A handle 127 is exposed on an upper surface of the enclosure 101. The handle 127 operates the switching mechanism 125 by a user's manual operating force.

Terminal parts 108, 218 that can be connected to a power source or load are provided on front and rear surfaces of the enclosure 101. The terminal parts 108, 218 are provided for each phase (or for each pole). For example, in the case of a 3-phase 4-pole molded case circuit breaker, four terminal parts may be provided on each of the power source side and the load side. The terminal parts 108, 218 consist of a power source side terminal part 108 and a load side terminal part 218.

A base assembly 102 is inserted and provided inside the enclosure 101. The base assembly 102 incorporates a contact part and an arc extinguishing part. The base assembly 102 is provided for each phase. For example, in the case of 3 phases, it consists of a R-phase, a S-phase, and a T-phase. Here, the switching mechanism 125 is provided in the S-phase base assembly 102.

Stationary contactors 120, 121 are fixedly provided inside the enclosure 101. The stationary contactors 120, 121 are connected to the terminal parts 108, 218. In the case of a double circuit breaker, the stationary contactors 120, 121 are provided on the power source side and the load side, respectively. That is, a power source side stationary contactor 120 and a load side stationary contactor 121 are provided. In this case, the power source side stationary contactor 120 may be directly connected to the power source side terminal part 108 or disposed integrally therewith. The load side stationary contactor 121 may be connected to the load side terminal part 218 through a trip mechanism (particularly the heater 210).

An arc extinguishing part (arc extinguishing apparatus) 105 is provided near the contact part (stationary contactor and movable contactor) to extinguish an arc generated during an interruption. In the case of a double circuit breaker, the arc extinguishing part 105 is provided on each of the power source side and the load side. The arc extinguishing part 105 may be configured with a pair of side walls and a plurality of grids coupled to the side walls at a predetermined interval. An arc generated at the contact part is divided into a plurality of grids.

A trip part 200 for detecting an abnormal current flowing in the circuit and tripping the switching mechanism is provided in part of the enclosure 101. The trip part 200 is usually provided on a load side. The trip part 200 may include a heater 210 connected to a load side terminal part 218, a bimetal 240 coupled to the heater 210 to detect heat and bend according to an amount of heat, a magnet 250 provided around the heater 210 to form a magnetic field in the event of a fault current, an armature 260 that is rotatably provided on the heater 210 to be attracted by a magnetic force of the magnet 250, a crossbar 270 provided so as to be rotatable by contact with the bimetal 240 or the armature 260, and a shooter 275 that is restrained or released by the rotation of the crossbar 270 to bind or release a nail 118 of the switching mechanism 125.

Typically, the bimetal 240 is bent by heat generated from the heater 210 to rotate the crossbar 270 so as to operate the switching mechanism 125 during a small current delay interruption, and the armature 260 is attracted by a magnetic force excited by the magnet 250 to rotate the crossbar 270 so as to operate the switching mechanism 125 during a large current instantaneous interruption.

The user's operating force is transmitted to the switching mechanism 125 through the handle 127. In order to transmit the power of the switching mechanism 125 to each phase, a pair of rotary pins 104 are provided in the switching mechanism 125. The rotary pin 104 is disposed with a length that spans all the phases and provided on a shaft assembly (or actuator assembly) 130.

The shaft assembly 130 is provided. The rotary pin 104 is provided to pass through the shaft assembly 130. The shaft assembly 130 rotates by receiving switching power of the switching mechanism 125 through the rotary pin 104. As the shaft assembly 130 rotates, the movable contactor 140 also rotates to be in contact with or separated from the stationary contactors 120, 121.

The shaft assembly 130 is configured to include a shaft body 131, a movable contactor 140, a shaft pin 165, and a spring 160.

The movable contactor 140 is inserted into and provided in an opening part 133 of the shaft body 131. The movable contactor 140 rotates counterclockwise or clockwise together with or independently with respect to the shaft body 131 to be in contact with or separated from the stationary contactors 120, 121 so as to energize or interrupt a line.

At both end portions of the movable contactor 140, movable contacts 141 that can be in contact with the stationary contacts 122, 123 of the stationary contactors 120, 121 are provided. The movable contacts 141 may be manufactured from a material with excellent conductivity and durability, such as a chromium-copper (Cr—Cu) alloy.

A fixing protrusion 142 that can catch one end of the spring 160 is disposed to protrude on a side surface of the movable contactor 140. One end of the spring 160 is fixed to the fixed protrusion 142, so as to allow the movable contactor 140 to receive a force that rotates counterclockwise in the drawing. Accordingly, the movable contactor 140 remains in a state of being inserted into the shaft body 131 by an elastic force of the spring 160 unless an external force is applied.

The movable contactor 140 rotates together with the shaft body 131 in a normal small current or large current interruption situation, but in the case of a current-limiting interruption, the movable contactor 140 rotates independently due to a sudden electromagnetic repulsion force. In this case, the movable contactor 140 comes into contact with the shaft pin 165 of the opening part to stop rotation. A catch groove (not shown) that can come into contact with the shaft pin 165 may be disposed on a rear surface of the movable contactor 140.

The rotation of the movable contactor 140 may be divided into three cases. The first case is when the user operates the handle 127 so as to allow the switching mechanism 125 connected to the handle 127 to rotate the shaft assembly 130 such that the movable contactor 140 rotates together with the shaft body 131. That is, the movable contactor 140 is restrained by the force of the spring 160 to move together with the shaft body 131. In other words, in this case, the shaft assembly 130 moves as a single unit with the movable contactor 140 and the shaft body 131.

The second case is when the restraint on the switching mechanism 125 is released due to an operation of the trip part 200 in response to the detection of a fault current, and the shaft assembly 130 rotates, causing the movable contactor 140 to also rotate. Even in this case, the movable contactor 140 is restrained by the force of the spring 160 to move together with the shaft body 131.

The third case is when the movable contactor 140 is separated from the stationary contactors 120, 121 to rotates due to an electromagnetic repulsion force (so-called current-limiting interruption) during the occurrence of a large fault current such as a short-circuit current. In this case, the movable contactor 140 rotates independently from the shaft body 131. The movable contactor 140 moves within the opening part 133 of the shaft body 131. When the movable contactor 140 overcomes the elastic force of the spring 160 due to a strong electromagnetic repulsion force to move clockwise, the movable contactor 140 is separated from the stationary contactors 120, 121. The movable contactor 140 is separated from the stationary contactors 120, 121 and fixed in a state where the movable contactor 140 is in contact with the shaft pin 165. That is, in this case (in the case of a current-limiting interruption), the shaft assembly 130 moves independently only with the movable contactor 140 while the shaft body 131 does not rotate.

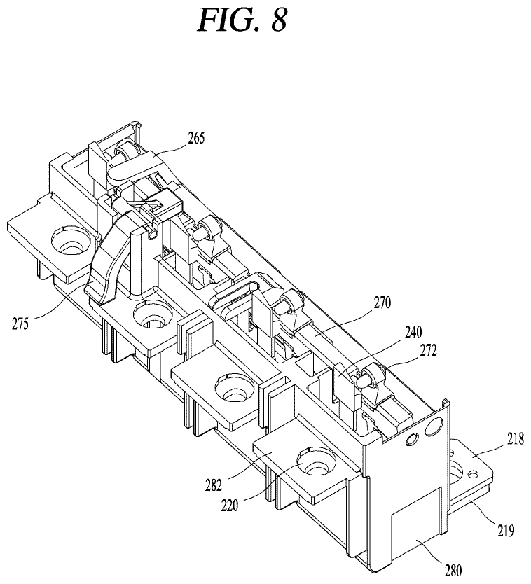

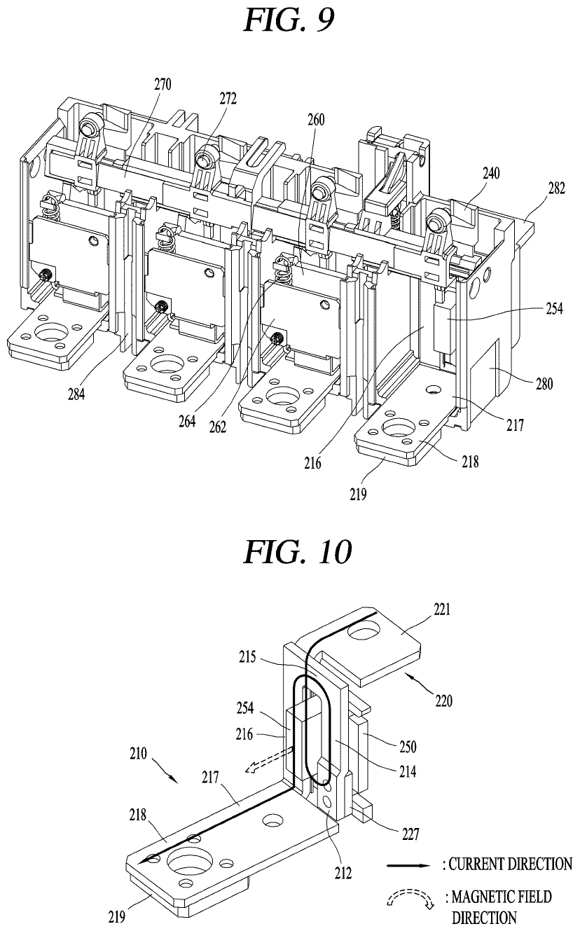

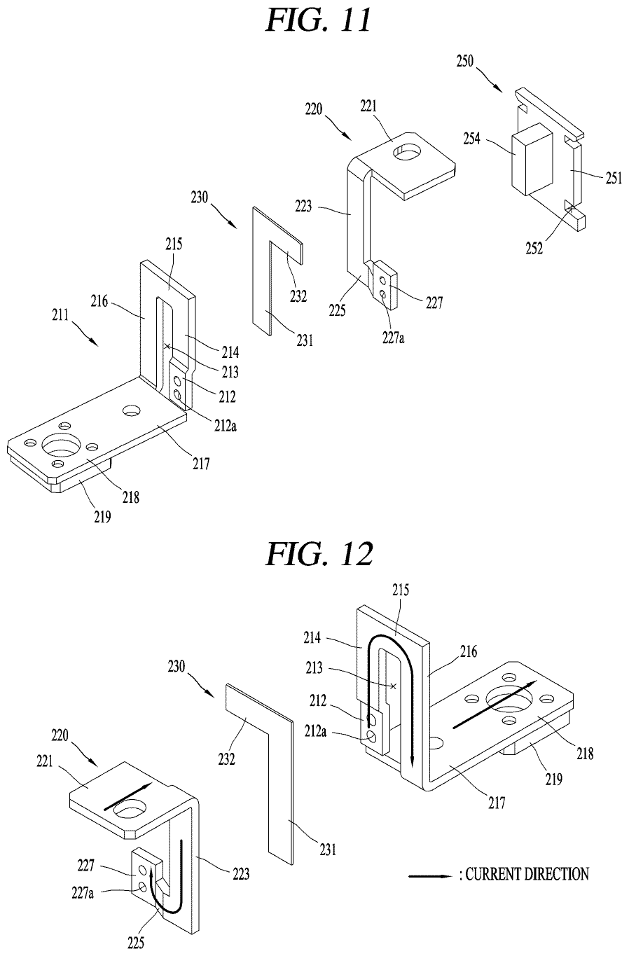

FIG. 8 and FIG. 9 are perspective views of a trip part applied to a molded case circuit breaker according to one embodiment of the present disclosure, which are viewed from different directions, FIG. 10 is a perspective view of a heater and a magnet applied to the trip part, FIG. 11 is an exploded perspective view of the heater and the magnet, and FIG. 12 is an exploded perspective view of the heater.

A trip part 200 for detecting an abnormal current flowing in the circuit and tripping the switching mechanism is provided in part of the enclosure 101. The trip part 200 is usually provided on a load side.

The trip part 200 includes a trip part case 280 that receives trip part elements, a heater 210 connected to part of a circuit, a bimetal 240 coupled to the heater 210 to detect heat and bend according to an amount of heat generated, a magnet 250 and an armature 260 provided around the heater 210, a crossbar 270 provided so as to be rotatable by contact with the bimetal 240 or the armature 260, and a shooter 275 that is restrained or released by the rotation of the crossbar 270 to bind or release a nail 118 of a switching mechanism 125.

The trip part case 280 is provided. The trip part case 280 receives and supports the elements of the trip part 200. The trip part case 280 may be formed of synthetic resin for insulation.

A contactor protection part 282 is disposed to protrude on a front side portion of the trip part case 280. The contactor protection part 282 surrounds, protects and insulates the load side stationary contactor 121.

The trip part case 280 is provided with an interphase partition wall 284 to separate each phase internally. The interphase partition wall 284 may be provided as a double wall.

A rear surface of the trip part case 280 is open so as to allow the terminal parts to be connected or insulated by the enclosure 101.

The heater 210 is provided in part of the circuit to generate heat or generate an induced current. The heater 210 consists of a conductor. The heater 210 is connected to the circuit to be energized. An upper part of the heater 210 is connected to the load side stationary contactor 121, and a lower part of the heater 210 is connected to the load side terminal part 218 to allow current to flow. The heater 210 sends a signal to the trip part when an overcurrent or large current flows. That is, when an overcurrent flows through the heater 210, heat is generated and transferred to the bimetal 240. In addition, when a large current flows through the heater 210, a magnetic field is formed by the induced current so as to generate a magnetic attraction force in the magnet 250.

The heater 210 is configured to generate an induced current in a form that can enhance the magnetic attraction force of the magnet 250. That is, the heater 210 forms a coil-shaped circular current like a solenoid. Accordingly, a coil-shaped circular current is formed so as to allow a magnetic field to be formed in a form that passes through the center of the circular current. It is an application of a magnetic field caused by a current flowing in a circular conductor.

To this end, the heater 210 may consist of a power source side heater part 220, a load side heater part 211, and an insulating member 230 disposed therebetween. Double plates in which the power source side heater part 220 and the load side heater part 211 partially overlap are disposed to implement a coil shape.

The power source side heater part 220 includes a power source side connection terminal 221, a power source side first vertical plate part 223, a power source side middle part 225, and a power source side coupling part 227. A current applied from a power source part, that is, a current that comes in through the load side stationary contactor 121, moves in a sequence of the power source side connection terminal 221, the power source side first vertical plate part 223, the power source side middle part 225, and the power source side coupling part 227.

The power source side connection terminal 221 is connected to the load side stationary contactor 121. That is, the power source side connection terminal 221 functions as a terminal part or connection part. Accordingly, the power source side connection terminal 221 is connected to the circuit to allow a current supplied from a power source to flow in.

The power source side first vertical plate part 223 is connected to the power source side connection terminal 221, and extends downward to be long in a vertical direction. The power source side first vertical plate part 223 is disposed to have a width less than half that of the power source side connection terminal 221. Furthermore, the power source side first vertical plate part 223 is connected to one side of the power source side connection terminal 221.

The power source side middle part 225 extends horizontally from a lower end of the power source side first vertical plate part 223. The power source side middle part 225 connects between the power source side first vertical plate part 223 and the power source side connecting part 227.

The power source side coupling part 227 is a portion where the power source side heater part 220 is coupled to the load side heater part 211. The power source side coupling part 227 is disposed in parallel to the power source side first vertical plate part 223. The power source side coupling part 227 has a predetermined gap from the power source side first vertical plate part 223. The gap is a portion connected by the power source side middle part 225.

The power source side coupling part 227 and the load side coupling part 212 are coupled to each other. The power source side coupling part 227 and the load side coupling part 212 may be coupled by bolts or pins. The power source side coupling part 227 and the load side coupling part 212 are each disposed to have coupling holes 212a, 227a into which bolts or pins can be inserted.

The load side heater part 211 includes a load side coupling part 212, a load side first vertical plate part 214, a load side middle part 215, a load side second vertical plate part 216, a load side flat plate part 217, and a load side terminal part 218. A current coming from the power source side heater part 220 moves in a sequence of the load side coupling part 212, the load side first vertical plate part 214, the load side middle part 215, the load side second vertical plate part 216, the load side flat plate part 217, and the load side terminal part 218.

The load side coupling part 212 is coupled to the power source side coupling part 227 of the power source side heater part 220. The power source side heater part 220 and the load side heater part 211 are directly connected only to the power source side coupling part 227 and the load side coupling part 212. Besides, other components of the power source side heater part 220 and other components of the load side heater part 211 are not directly connected to one another.

The load side first vertical plate part 214 extends upward from the load side coupling part 212. In the load side first vertical plate part 214, a current flowing from the

### Power Source Side Heater Part 220 Moves Upward.

The load side middle part 215 extends horizontally from an upper end of the load side first vertical plate part 214. The load side middle part 215 connects between the load side first vertical plate part 214 and the load side second vertical plate part 216.

The load side second vertical plate part 216 extends downward from the load side middle part 215. The load side second vertical plate part 216 is disposed in parallel to the load side first vertical plate part 214. A current flowing from the load side first vertical plate part 214 and the load side middle part moves downward on the load side second vertical plate part 216.

The load side second vertical plate part 216 is disposed to have a predetermined gap from the load side first vertical plate part 214. That is, a magnetic groove 213 is disposed between the load side first vertical plate part 214 and the load side second vertical plate part 216. The magnetic groove 213 provides a space into which the protruding part 254 of the magnet 250 is inserted.

The load side second vertical plate part 216 overlaps the power source side first vertical plate part 223. That is, they are disposed to form double plates. However, the load side second vertical plate part 216 and the power source side first vertical plate part 223 are disposed to have a predetermined gap between each other by the insulating member 230. Therefore, a current does not flow directly from the power source side first vertical plate part 223 to the load side second vertical plate part 216.

The load side flat plate part 217 extends to bend from the load side second vertical plate part 216. The load side flat plate 217 is connected to the load side terminal part 218.

A width of the load side first vertical plate part 214 and the load side second vertical plate part 216 is disposed to be less than half that of the load side flat plate part 217. In addition, a width of the load side first vertical plate part 214 and the load side second vertical plate part 216 is disposed to be less than half that of the power source side connection terminal 221.

The load side terminal part 218 extends from the load side flat plate part 217. The load side terminal part 218 constitutes a terminal part to which the load is connected. A current applied from the power source to the heater 210 is transmitted to the load through the load side terminal part 218.

A support part 219 may be provided on a lower surface of the load side terminal part 219.

The insulating member 230 is interposed between the power source side heater part 220 and the load side heater part 211. The insulating member 230 may consist of an insulating paper. Specifically, the insulating member 230 may be disposed in an ‘Γ’ shape. That is, the insulating member 230 may consist of an insulating vertical plate part 231 and an insulating horizontal plate part 232. The insulating member 230 prevents the power source side heater part 220 and the load side heater part 211 from being directly connected to each other except at the coupling part. The insulating vertical plate part 231 is interposed between the power source side first vertical plate part 223 and the load side second vertical plate part 216. The insulating horizontal plate part 232 is interposed between an upper part of the power source side first vertical part 223 (or one side surface of the power source side connection terminal 221) and the load side middle part 215.

A current rotates approximately twice in an elliptical shape while passing from the power source side heater part 220 to the load side heater part 211 so as to form a circular current. Accordingly, a magnetic field that passes through the circular current is generated. The magnetic field passes through the magnetic groove 213. FIGS. 10 and 12 shows a direction of a current flowing through the heater.

The bimetal 240 is made up of two metal plates with different thermal conductivities to bend when heat is generated. Since the bimetal 240 is in contact with the heater 210, when heat is transferred, it bends to rotate the crossbar 270. The bimetal 240 performs an overcurrent trip operation.

The amateur 260 is provided in the heater 210. Specifically, the armature 260 is provided on the load side flat plate part 217 of the load side heater part 211. An amateur is shown in FIGS. 7 and 9.

The amateur 260 is provided by an amateur support part 262 and a return spring 264. The armature 260 is formed of a magnetic material, and when a magnetic force of the magnet 250 becomes stronger than an elastic resistance of the return spring 264, the armature overcomes the elastic resistance to be attracted (rotated) toward the magnet 250.

The magnet 250 is provided behind the heater 210. When a sudden change in current occurs in the heater 210, the magnetic attraction force of the magnet 250 increases due to the magnetic field caused by the induced current. The magnet is clearly shown in FIGS. 10 and 11.

The magnet 250 may be disposed in a ‘T’ shape when viewed from above.

The magnet 250 may consist of a fixing plate part 251 and a protruding part 254.

A fixing groove 252 is disposed in the fixing plate part 251 to be fixedly provided in the trip part case 280. The fixing plate part 251 is disposed on a rear surface (in a direction of the contact part) of the heater 210.

The protruding part 254 protrudes in a direction orthogonal to the fixing plate part 251. The protruding part 254 is inserted into the magnetic groove 213 of the heater 210. That is, the protruding part 254 passes through between the power source side first vertical plate part of the power source side heater part 220 and the load side first vertical plate part of the load side heater part 211. Additionally, the protruding part 254 is inserted into a gap between the load side first vertical plate part 214 and the load side second vertical plate part.

The crossbar 270 is rotated by the bimetal 240 or armature 260 to release the shooter 275 from its restraint and operate the switching mechanism 125. The crossbar 270 is provided with an adjusting screw 272 for adjusting a gap with respect to the bimetal 240.

According to an instantaneous trip apparatus of a molded case circuit breaker in accordance with one embodiment of the present disclosure, a heater is disposed in a solenoid shape to generate a circular current. Therefore, a direction of a magnetic field formed in the magnet matches a direction in which the armature moves so as to enhance an instantaneous attraction force.

This allows the armature to operate within an instantaneous reference range even at low rated currents.

The heater consists of double plates of a power source side heater part and a load side heater part connected thereto so as to form a circular current.

An insulating member is interposed between the power source side heater part and the load side heater part to facilitate the flow of current between the double plates.

The foregoing embodiments are examples of the best practices for implementing the present disclosure, and it will be apparent to those skilled in this art that various changes and modifications may be made thereto without departing from the subject matter of the present disclosure. Therefore, those embodiments are not intended to limit the technical concept of the present disclosure but are merely intended to illustrate the present disclosure. Therefore, it should be understood that the scope of the technical concept of the present disclosure is not limited by those embodiments. That is, the scope protected by the present disclosure should be construed by the accompanying claims, and all the technical concept within the equivalent scope of the disclosure should be construed to be included in the scope of the right of the present disclosure.

### Description of Reference Numerals

100 Molded case circuit breaker
101 Enclosure
108 Power source side terminal part
218 Load side terminal part
120,121 Stationary contactor
125 Switching mechanism
130 Shaft assembly
140 Movable contactor
200 Trip part
210 Heater
211 Power source side heater part
220 Load side heater part
230 Insulating member
240 Bimetal
250 Magnet
251 Fixing plate part
254 Protruding part
260 Amateur
270 Crossbar
275 Shooter
280 Trip part case

1. An instantaneous trip apparatus of a molded case circuit breaker, the apparatus comprising:
a heater connected to a circuit;
a magnet provided adjacent to the heater; and
an armature that is rotatably provided to be attracted in a direction of the magnet when the magnet is magnetized, wherein a magnetic groove is disposed in a central portion of the heater, and a protruding part is provided on the magnet so as to be inserted into the magnetic groove to protrude toward the armature.

2. The apparatus of claim 1, wherein the heater comprises:
a power source side heater part connected to a power source side, a load side heater part some of which is disposed to overlap the power source side heater part, and
an insulating member interposed between the power source side heater part and the load side heater part.

3. The apparatus of claim 2, wherein the power source side heater part comprises:
a power source side connection terminal connected to a power source side;
a power source side first vertical plate part that is connected to the power source side connection terminal to extend downward;
a power source side middle part extending horizontally from the power source side first vertical plate part; and
a power source side coupling part connected to the power source side middle part.

4. The apparatus of claim 3, wherein the load side heater part comprises:
a load side coupling part coupled to the power source side coupling part;
a load side first vertical plate part extending upward from the load side coupling part;
a load side middle part extending horizontally from the load side first vertical plate part;
a load side second vertical plate part extending downward from the load side middle part to be disposed in parallel to the load side first vertical plate part;
a load side flat plate part that extends by bending from the load side second vertical plate part; and
a load side terminal part connected to the load side flat plate part.

5. The apparatus of claim 3, wherein a width of the power source side first vertical plate part is disposed to be less than half that of the power source side connection terminal.

6. The apparatus of claim 4, wherein a width of the load side first vertical plate part and the load side second vertical plate part is disposed to be less than half that of the load side flat plate part.

7. The apparatus of claim 4, wherein the load side second vertical plate part and the power source side first vertical plate part are disposed to overlap with the insulating member interposed therebetween.

8. The apparatus of claim 4, wherein the magnetic groove is disposed between the load side first vertical plate part and the load side second vertical plate part.

9. The apparatus of claim 2, wherein the insulating member comprises an insulating vertical plate part and an insulating horizontal plate part.

10. The apparatus of claim 1, wherein the magnet comprises:
a fixing plate part fixedly provided in a trip part case; and
a protruding part that protrudes in a orthogonal direction from the fixing plate part to be inserted into the magnetic groove.

11. The apparatus of claim 10, wherein a fixing groove to be fixedly provided in the trip part case is disposed on the fixing plate part.
